(19) United States
(12) Patent Application Publication
(10) Pub. No.: US 2006/0048598 A1
(43) Pub. Date: Mar. 9, 2006

(54) End fitting for a cable

(76) Inventors: Jerome Pierre Roussel, Colmar (FR); Paul Carrington, Halesowen (GB)

Correspondence Address: CARLSON, GASKEY & OLDS, P.C., 400 WEST MAPLE ROAD, SUITE 350, BIRMINGHAM, MI, 48009, US

(21) Appl. No.: 11/221,364

(22) Filed: Sep. 7, 2005

(30) Foreign Application Priority Data
Sep. 8, 2004 (EP) 04255441.0

(51) Int. Cl. F16C 1/22

(52) U.S. Cl. 74/502.6

(57) ABSTRACT

An end fitting for a cable provides for the axial transmission of an input movement or an output movement to or from a moveable body relative to a fixed body. The end fitting has a pivot portion spaced from a clip portion. The pivot portion is engageable with a pivot region of the fixed body to allow the end fitting to rotate about the pivot portion to rotatably engage the clip portion with a clip region of the fixed body, securing the cable to the fixed body.

### REFERENCE TO RELATED APPLICATION

This application claims priority to European Patent Application EP 04255441.0 filed on Sep. 8, 2004.

### BACKGROUND OF THE INVENTION

The present invention relates generally to an end fitting for a cable, particularly, but not exclusively for, an end fitting of a Bowden cable used in relation to the control of vehicle door latches.

Cable linkages for vehicles can be used in light commercial vehicles, such as panel vans (i.e., vans in which the load space is enclosed). These typically include a relatively large rear opening that is closeable by two rear doors hinged to a rear most edge of each side of the van. A latch is typically provided part way up the shut-face of one of the rear doors. The latch is arranged to latch with a complementary striker provided on the shut face of the other of the rear doors when the doors are closed. Typically, the latch may also operate supplementary latches which are fitted to the upper and lower edges of the door to which the latch is fitted via Bowden cable connections.

Often, the cables have to be connected to a latch mechanism in the interior of the latch “blind,” i.e., with the latch mechanism enclosed within a housing except for a small opening through which the cable is inserted. This can make the assembly process difficult, time consuming and therefore costly and prone to error. In addition, it is often also difficult, if not impossible, to disassemble the connection for maintenance without damaging the cable, fitting or latch.

The present invention seeks to overcome, or at least mitigate, the problems of the prior art.

### SUMMARY OF THE INVENTION

Accordingly, one aspect of the present invention provides an end fitting for a cable for the axial transmission of an input movement or an output movement to or from a moveable body relative to a fixed body. The end fitting has a pivot portion spaced from a clip portion. The pivot portion is engageable with a pivot region of the fixed body to allow the end fitting to rotate about the pivot portion to rotatably engage the clip portion with a clip region of the fixed body, thereby securing the cable to the fixed body.

A further aspect of the present invention provides an end fitting assembly including an end fitting for a cable for the axial transmission of an input movement or an output movement to or from a moveable body relative to a fixed body. The end fitting has a pivot portion spaced from a clip portion. The pivot portion is engageable with a pivot region of the fixed body to allow the end fitting to rotate about the pivot portion to rotatably engage the clip portion with a clip region of the fixed body, thereby securing the cable to the fixed body. The fixed body is sheet-like and includes an elongate aperture to receive the fitting.

Another aspect of the present invention provides a method of mounting a cable end fitting to a fixed body. The end fitting includes a pivot portion spaced from a clip portion. The method includes the steps of engaging the pivot portion of the fitting with a complementary pivot region of the fixed body, pivoting the end fitting about the pivot portion and engaging the clip portion with the clip region of the fixed body.

### BRIEF DESCRIPTION OF THE DRAWINGS

Embodiments of the present invention will now be described, by way of example only, with reference to the accompanying drawings in which:

FIG. 1 is a view of rear doors of a van or light commercial vehicle illustrating an arrangement of a handle, latches, and connecting cables;

FIG. 2A is an exploded view of a prior art cable end fitting and the components to which it is secured;

FIG. 2B is an assembled view of the prior art cable end fitting and the components to which it is secured;

FIG. 3 is an isometric view of an end fitting of the present invention secured to a latch viewed from a latch interior;

FIG. 4 is an isometric view of the end fitting of the present invention secured to the latch viewed from the latch interior;

FIG. 5 is an isometric view of the fitting of FIG. 3 viewed from the latch exterior;

FIG. 6 is a partial cross-section through the latch of FIGS. 3 to 5 during assembly of the end fitting thereto;

FIG. 7 is a perspective view of another portion of the latch showing levers to which the cable is to be secured; and

FIG. 8 is a perspective view of the latch illustrating two end fittings of the present invention in place.

### DETAILED DESCRIPTION OF THE PREFERRED EMBODIMENT

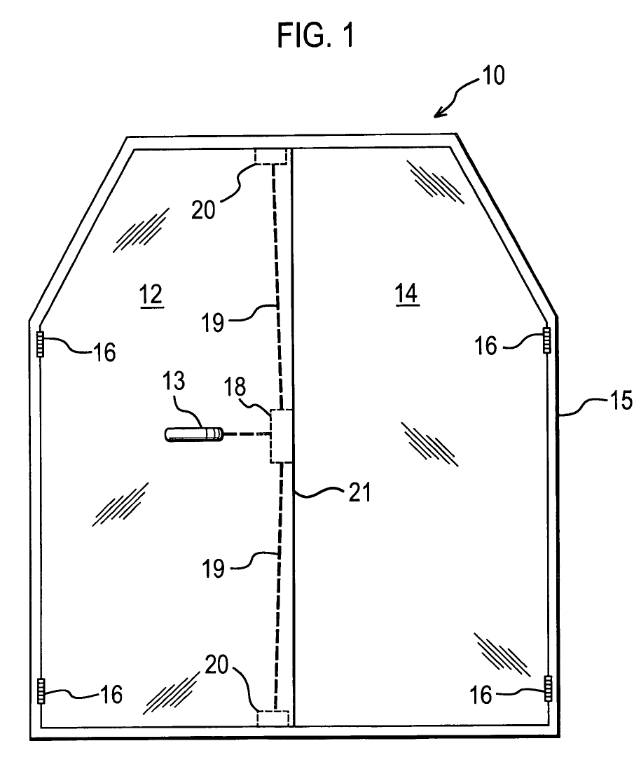

FIG. 1A illustrates a light commercial vehicle, such as a van 10. Only the rear of the van 10 is visible and includes a first rear door 12 and a second rear door 14 pivotally mounted to a door surround 15 by hinges 16. In use, the first rear door 12 is opened first, followed by the second rear door 14, in order to gain full access to the vehicle load area. A primary latch 18 is mounted proximate a shut-face of the first rear door 12 to engage and releaseably retain a complementary striker (not shown) provided on an opposed shut-face of the second rear door 14. The primary latch 18 is lockable to provide some protection from unauthorized access to the load space of the van 10.

Linkages 19 in the form of Bowden cables extend from the top and the bottom of the primary latch 18 to connect the primary latch 18 with secondary latches 20 mounted near the top and the bottom of the first rear door 12. The secondary latches 20 are positioned to engage complementary strikers (not shown) mounted to the door surround 15 of the van 10. Thus, when the first rear door 12 is closed, it is latched to both the second rear door 14 and to the door surround 15, thereby securely retaining both the first rear door 12 and the second rear door 14 in a closed position relative to the door surround 15. When the primary latch 18 is unlocked, pulling on an outside release handle 13 simultaneously releases both the primary latch 18 and the secondary latches 20 by virtue of the linkages 19.

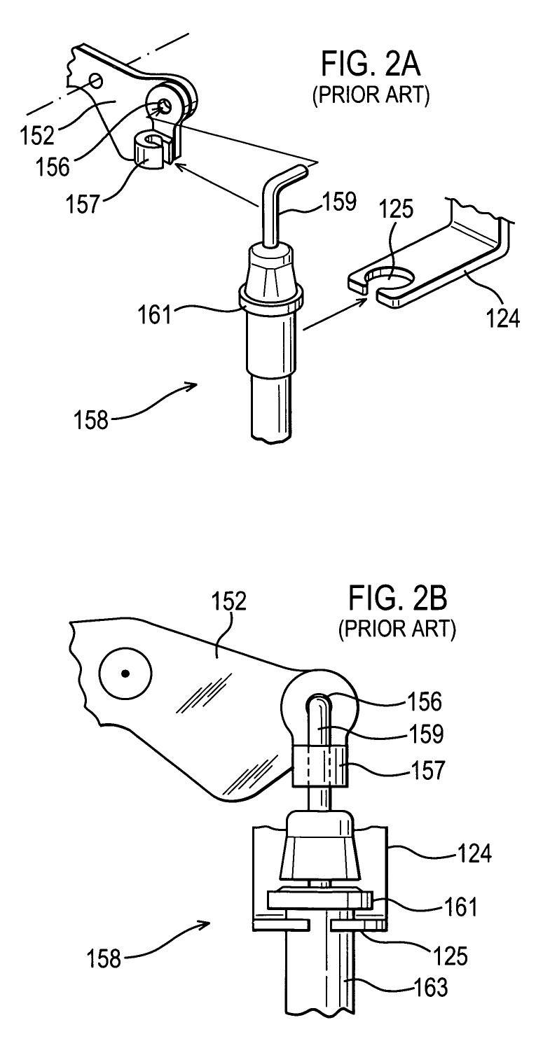

Turning to FIGS. 2A and 2B, a Bowden cable 158 with a prior art end fitting including an enlarged end 161 of an outer sheath 163 and an ‘L’ shaped end 159 of an inner cable. In order for a lever 152 to be actuated via the Bowden cable 158, the Bowden cable 158 must be clipped in a first direction to a recess 125 of a fixed support 124 and also simultaneously clipped in a second direction to a ‘C’ shaped holder 157 at the end of the lever 152 and inserted in a third direction into a hole 156 in the lever 152. A significant degree of dexterity is required to successfully assemble a Bowden cable connection in this way, and assembly in “blind” conditions would be near impossible.

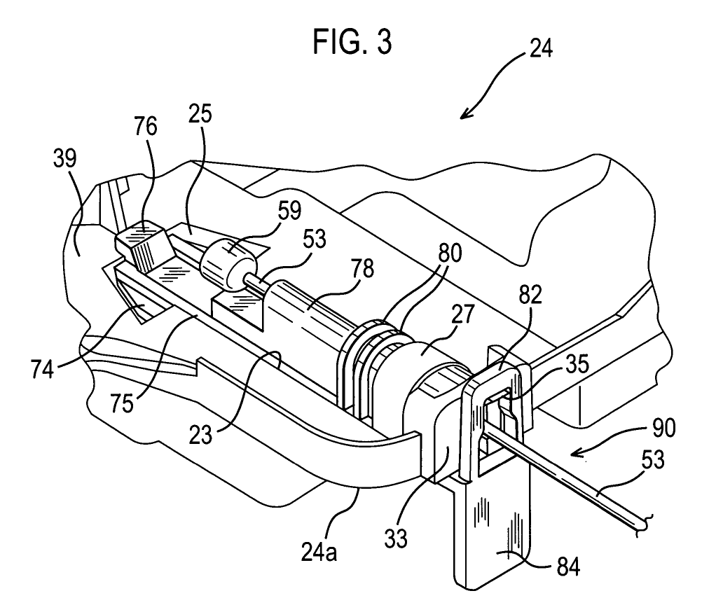

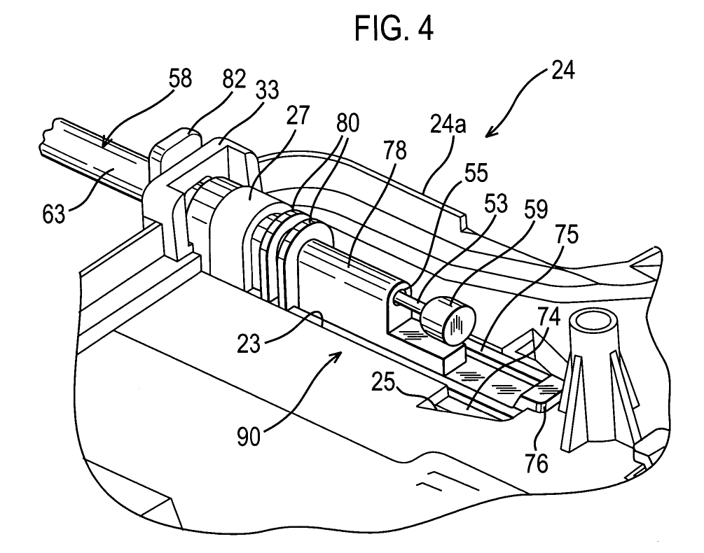

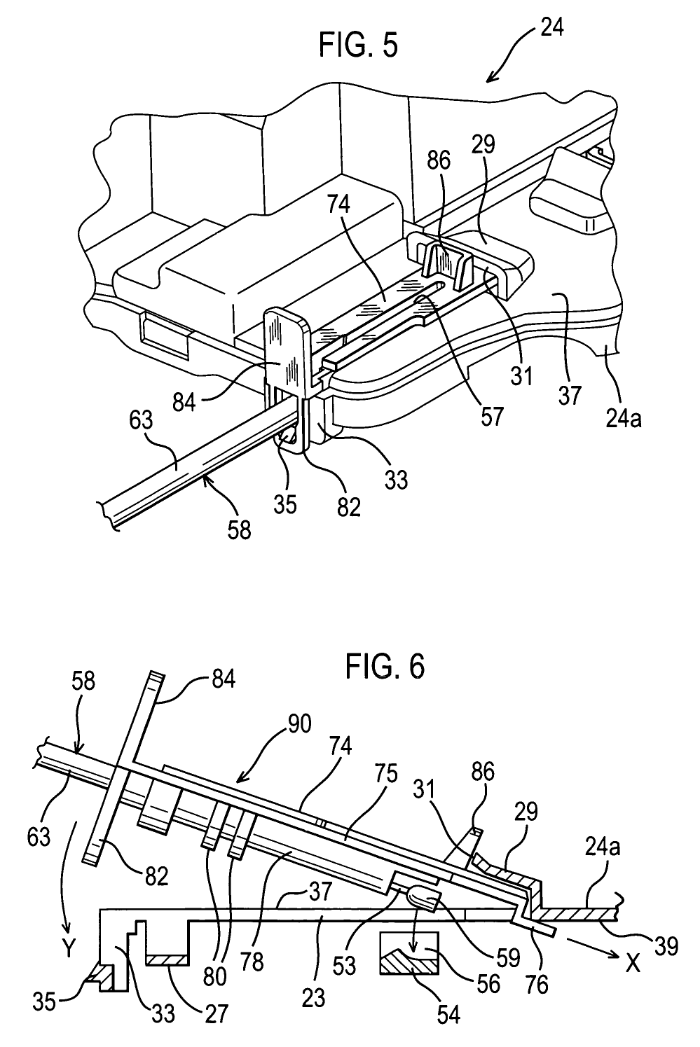

With reference to FIGS. 3 to 6, an end fitting 90 according to an embodiment of the present invention is illustrated in conjunction with a cooperating housing portion 24a of a latch housing 24 of the primary latch 18. The end fitting 90 includes a generally elongate substantially rigid body 75 formed from injection moulded plastics or the like.

From the free end of the body 75 inwards along a longitudinal axis of the body 75, the end fitting 90 includes a pivot portion in the form of an axially extending offset rib 76 provided to engage an edge of an interior face 39 of the housing portion 24a. A widened cover portion 74 is configured to contact an exterior face 37 of the housing portion 24a along a majority of the length of the end fitting 90. A stop 86 projects from the cover portion 74. A cable guide portion 78 including an axial bore 55 and a trough 57 is arranged to project into the interior of the housing 24 and has a pair of retaining ribs 80 on its surface configured to maintain the end fitting 90 in place in an axial direction. A clip portion in the form of a clip 82 is arranged for an engagement with a tooth 35 of the housing portion 24a (described in more detail below), and an unclip tab 84 projects away from the clip 82 and is in substantially axial alignment therewith.

A Bowden cable 58 enters the guide portion 24 through an opening in the clip 82 and includes an outer sheath 63 that terminates within the cable guide portion 78 and an inner cable 53 that extends through the axial bore 55 of the cable guide portion 78 and terminates in an enlarged end 59. The outer sheath 63 is secured axially relative to the cable guide portion 78 by gluing, welding or crimping, for example. The inner cable 53 can slide axially relative to the end fitting 90.

In addition, the housing portion 24a is configured so that the end fitting 90 can be secured thereto. In the same direction, this includes a guide 29 projecting from the exterior face 37 of the housing portion 24a with an enlarged mouth portion 31 to aid in the end fitting 90 of the offset rib 76. The interior face 39 of the housing portion 24a proximate the guide 29 forms a pivot region engageable by the offset rib 76. An elongate aperture 23 extends from the mouth to the edge of the housing portion 24a, through which the body 75 of the end fitting 90 is able to fit. A ‘U’ shaped retainer 27 extends transversely across the aperture 23 and projects into the interior of the housing 24 to maintain the end fitting 90 in place axially due to cooperation with the retaining rib 80. A clip region including the tooth 35 is mounted proximate an end opening 33 in the housing portion 24a and is positioned to cooperate with the clip 82 and thus prevent the end fitting 90 pivoting away from the housing portion 24a when assembled.

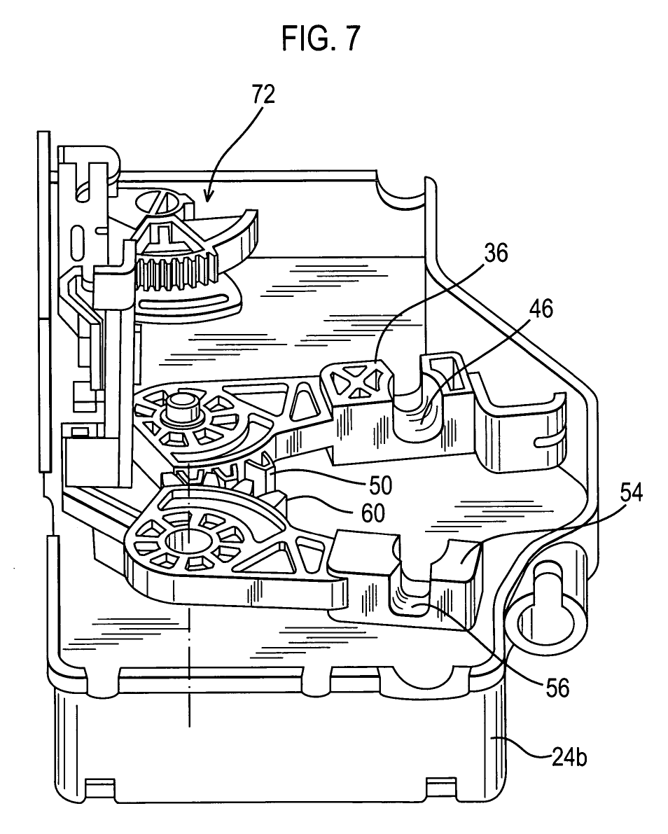

FIG. 7 illustrates a second housing portion 24b of the latch housing 24 that mates along its free edge with the housing portion 24a and that additionally incorporates a latch mechanism 72. The latch mechanism 72 includes a pawl (not shown) configured to releaseably retain a claw-type latch bolt (not shown) and thus engage a striker (not shown) to hold the door closed, as is well known. The latch mechanism 72 further includes first and second auxiliary latch release arms 54 and 36 including gear teeth 60 and 50, respectively, so that motion of one arm results in simultaneous motion of the other arm in an opposite direction. The first and second auxiliary latch release arms 54 and 36 are moveable in response to an action that also releases the striker from engagement with the latch bolt, be it either a manual input from a door handle or a power input from an electric motor or other actuator.

The first and second auxiliary latch release arms 54 and 36 each include a cup-shaped recess 56 proximate their free ends dimensioned so that the enlarged end 59 of the inner cable 53 may engage therein. In the case of first auxiliary latch release arm 54, counter-clockwise motion thereof when viewed in FIG. 7 results in axial motion of the inner cable 53 in a left to right direction when viewed in FIG. 6.

With particular reference to FIG. 6, the end fitting 90 is assembled to the primary latch 18 as follows. The end fitting 90 is first moved in direction X such that the offset rib 76 engages the interior face 39 of the housing portion 24a. The stop 86 contacts the edge of the mouth portion 31 of the guide 29, so that the end fitting 90 is positioned relative to the housing portion 24a, as illustrated in FIG. 6. The guide 29 on the housing portion 24a assists in the correct location of the offset rib 76. The stop 86 ensures the correct axial alignment of the end fitting 90 relative to the housing portion 24a is achieved. Furthermore, the offset rib 76 acts, in effect, as a pivot point for the subsequent step of pivoting the end fitting 90 in a counter-clockwise direction Y so that the clip 82 is brought into engagement with tooth 35, the retaining rib 80 is brought into the proximity of ‘U’ shaped retainer 27, and the enlarged end 59 of the inner cable 53 is positioned in the cup-shape recess 56 of the first auxiliary latch release arm 54. Additionally, the cover portion 74 of the body 75 is brought into contact with exterior face 37 of the housing portion 24a along the majority of the length of the aperture 23 to provide a seal against the ingress of dust, moisture, etc. to the interior of the latch housing 24.

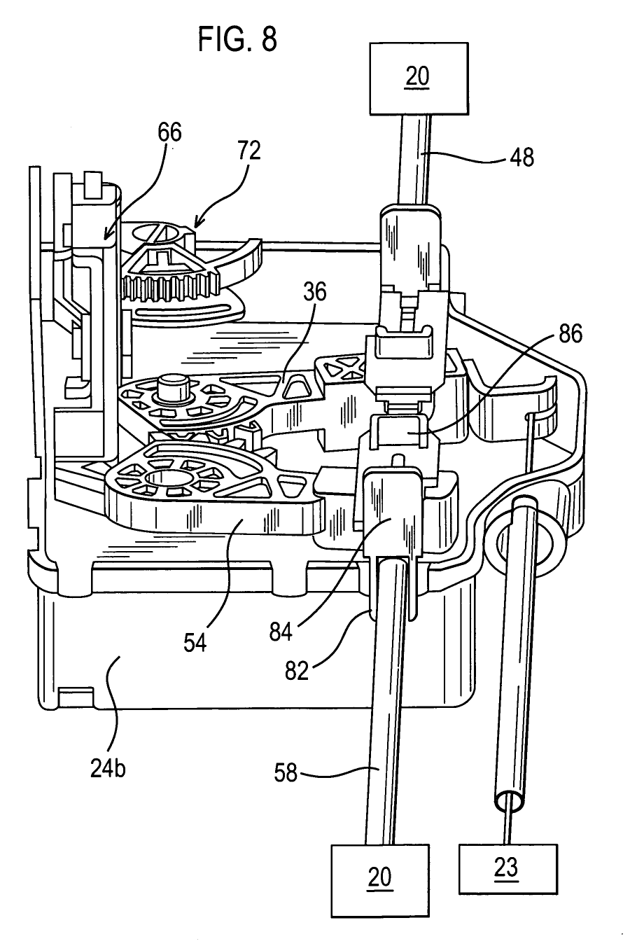

The end fitting 90 is shown in this installed position relative to the housing portion 24a in FIGS. 3, 4 and 5, and furthermore relative to the second housing portion 24b and the first auxiliary latch release arm 54 in FIG. 8. FIG. 8 additionally illustrates a second Bowden cable 48 connected to a secondary auxiliary latch 20 in the same manner.

If removal of the end fitting 90 from the housing portion 24a is needed, for example for maintenance reasons, an unclip tab 84 may be pushed in a clockwise direction when viewed in FIG. 6, disengaging the clip 82 from the tooth 35, thereby permitting the pivoting and axial withdrawal of the end fitting 90 from the housing 24 and the first auxiliary latch release arm 54 in essentially the reverse of the assembly procedure.

The end fitting 90 described above enables cables to be connected to latches rapidly and with the minimum amount of skill and dexterity. Disassembly of the end fitting 90 may also be easily achieved. Furthermore, the configuration of the end fitting 90 enables a good seal with the latch housing 24 to be achieved and ensures that the end fitting 90 is securely mounted to the housing 24 so the two do not become separated in use.

Numerous changes may be made within the scope of the present invention and that a fitting of the present invention may be used in other applications when a cable, in particular a Bowden cable, needs to be fitted to an input or output element such as a lever. For example, a suitable alternative form of securement may be used in place of the tooth and clip arrangement, and the clip may be adapted so that the non-destructive disassembly of the fitting from a corresponding input or output is prevented. The shape of the enlarged end portion of the inner cable may be adapted according to particular user requirements. The stop rib may be dispensed with and the shape of the offset rib relied upon to prevent axial movement. The unclip tab may be dispensed with if provision for removal of the fitting is not required.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. An end fitting for a cable for the axial transmission of an input movement or an output movement along an axis of the cable to or from a moveable body relative to a fixed body, the end fitting comprising:
a clip portion; and
a pivot portion spaced from the clip portion, wherein the pivot portion is engageable with a pivot region of the fixed body to allow the end fitting to rotate about the pivot portion to rotatably engage the clip portion of the end fitting with a clip region of the fixed body to secure the cable to the fixed body.

2. The end fitting according to claim 1 wherein the pivot portion further comprises an abutment to engage the fixed body and restrict relative movement of moveable body relative to the fixed body in at least one direction transverse to the axis of the cable.

3. The end fitting according to claim 1 wherein the pivot portion further comprises an abutment to engage the fixed body and restrict movement of the moveable body relative to the fixed body in at least one axial direction.

4. The end fitting according to claim 1 wherein the clip portion comprises a snap fitting clip for automatically engaging the fixed body by pivotal motion.

5. The end fitting according to claim 4 further comprising a tab manually operable to release the snap fitting clip.

6. The end fitting according to claim 1 further comprising a cover portion to prevent foreign matter from entering the fixed body.

7. The end fitting according to claim 1 wherein the cable includes an end, and the end fitting positioning the end of the cable to engage the moveable body when the end fitting is fitted.

8. The end fitting according to claim 1 wherein the cable includes an outer sheath and the end fitting receives the outer sheath of the cable.

9. The end fitting according to claim 8 wherein the end fitting transmits axial loads in the outer sheath of the cable to the fixed body.

10. An end fitting assembly comprising:
an end fitting for a cable for the axial transmission of an input movement or an output movement to or from a moveable body relative to a fixed body, wherein the end fitting includes:
a clip portion; and
a pivot portion spaced from the clip portion, wherein the pivot portion is engageable with a pivot region of the fixed body to allow the end fitting to rotate about the pivot portion to rotatably engage the clip portion of the end fitting with a clip region of the fixed body to secure the cable to the fixed body,
wherein the fixed body is sheet-like and includes an elongate aperture to receive the end fitting.

11. The end fitting assembly according to claim 10 wherein the fixed body comprises a guide to guide the pivot portion of the end fitting into contact with the pivot region of the fixed body.

12. A method of mounting a cable end fitting to a fixed body, the cable end fitting comprising a pivot portion spaced from a clip portion, the method comprising the steps of:
engaging the pivot portion of the cable end fitting with a complementary pivot region of the fixed body;
pivoting the cable end fitting about the pivot portion; and
engaging the clip portion with the clip region of the fixed body.

13. The method according to claim 12 wherein in the step of engaging the pivot portion, the cable end fitting is further restrained in at least one of an axial direction and a transverse direction relative to the fixed body.

14. The method according to claim 12 wherein in the step of pivoting the cable, the cable is brought into engagement with a moveable body and axial movement is transmitted between the moveable body and the fixed body in at least one direction.

15. The method according to claim 12 wherein the step of engaging the clip portion automatically occurs as a result of performing the step of pivoting the cable end.
